(19) United States
(12) Patent Application Publication
(10) Pub. No.: US 2007/0275279 A1
(43) Pub. Date: Nov. 29, 2007

(54) FUEL CELL SYSTEM

(75) Inventors: Yong-Jun Hwang, Seoul (KR); Jung-Gyu Park, Seoul (KR); Myung-Seok Park, Gyeonggi-Do (KR)

Correspondence Address: GREENBLUM & BERNSTEIN, P.L.C., 1950 ROLAND CLARKE PLACE, RESTON, VA, 20191, US

(73) Assignees: LG ELECTRONICS INC., Seoul (KR); LG Chem, Ltd., Seoul (KR)

(21) Appl. No.: 11/627,539

(22) Filed: Jan. 26, 2007

(30) Foreign Application Priority Data
May 25, 2006 (KR) 10-2006-0047257

(51) Int. Cl. H01M 8/04

(52) U.S. Cl. 429/23

(57) ABSTRACT

A fuel cell system includes a stack unit which generates electricity by an electrochemical reaction between air and hydrogen. A fuel supply unit supplies hydrogen to the stack unit, and an air supply unit supplies air to the stack unit. A load corresponding unit measures an amount of electricity drawn from the stack unit by a load, and controls an amount of electricity generated by the stack unit based on the measurement.

### RELATED APPLICATION

The present disclosure relates to subject matter contained in Korean Patent Application No. 10-2006-0047257, filed on May 25, 2006, which is herein expressly incorporated by reference in its entirety.

### BACKGROUND OF THE INVENTION

1. Field of the Invention

The present invention relates to a fuel cell system and, more particularly, to a fuel cell system capable of controlling an amount of hydrogen and air supplied to a stack unit according to a size of a load.

2. Description of the Conventional Art

FIG. 1 shows a conventional Proton Exchange Membrane Fuel Cell (PEMFC) system, in which hydrocarbon-based (CH-based) fuel such as, for example, liquefied natural gas (LNG), liquefied petroleum gas (LPG), methanol (CH₃OH), or gasoline, sequentially undergoes a desulfurization process, a modification reaction and a hydrogen purification process to purify hydrogen (H₂) to be used as fuel.

As shown in FIG. 1, the related art fuel cell system includes a fuel supply unit 10 which extracts hydrogen (H₂) from fuel and supplies it to a stack unit 30, an air supply unit 20 which supplies air to the stack unit 30 and the fuel supply unit 10, the stack unit 30, which includes an anode 31 and a cathode 32 which generate electricity from an electrochemical reaction between the supplied hydrogen and air, and an electricity output unit 40 which converts electricity generated in the stack unit 30 into an alternating current (AC) and supplies it to a load, such as a home appliance, for example.

In the conventional fuel cell system, the amount of hydrogen supplied by the fuel supply unit 10 to the anode 31 of the stack unit 30 and the amount of air supplied by the air supply unit 20 to the cathode 32 of the stack unit 30 are constant, regardless of the size of the load.

Thus, when a small load requiring only a small amount of electricity is connected to the conventional fuel cell system, more hydrogen and air than are needed are supplied to the stack unit. Conversely, when a large load requiring a large amount of electricity is connected to the conventional fuel cell system, an insufficient amount of hydrogen and air are supplied to the stack unit. Further, because the fuel cell system cannot a load which is too large, hydrogen is wasted, resulting in degradation of the overall performance of the fuel cell system.

### BRIEF DESCRIPTION OF THE INVENTION

One of the features of the present invention is a fuel cell system which controls an amount of air and/or hydrogen supplied to a stack unit based on a size of a load connected to the fuel cell system.

To achieve at least this feature, there is provided a fuel cell system which includes a stack unit which generates electricity by an electrochemical reaction between air and hydrogen, a fuel supply unit which supplies hydrogen to the stack unit, an air supply unit which supplies air to the stack unit, and a load corresponding unit which measures an amount of electricity drawn from the stack unit by a load, and controls an amount of electricity generated by the stack unit based on the measurement.

The load corresponding unit may control the amount of electricity generated by the stack unit by controlling an amount of hydrogen supplied to the stack unit. The load corresponding unit may include a fuel circulation blower which re-circulates hydrogen discharged from the stack unit back to the stack unit, and a fuel controller which controls a driving voltage of the fuel circulation blower based on the measurement. The measurement may be a current value measurement, and the fuel controller may increase the driving voltage of the fuel circulation blower when the current value measurement increases relative to a prior current value measurement, and decrease the driving voltage of the fuel circulation blower when the current value measurement decreases relative to a prior current value measurement.

The load corresponding unit may control the amount of electricity generated by the stack unit by controlling an amount of air supplied to the stack unit. The load corresponding unit may include an air circulation blower which supplies air from the air supply unit to the stack unit, and an air controller which controls a driving voltage of the air circulation blower based on the measurement. The measurement may be a current value measurement, and the air controller may increase the driving voltage of the air circulation blower when the current value measurement increases relative to a prior current value measurement, and decrease the driving voltage of the air circulation blower when the current value measurement decreases relative to a prior current value measurement.

There is also provided a method for controlling an amount of electricity generated by a fuel cell system which includes supplying hydrogen and air to a stack unit, generating electricity by an electrochemical reaction between the air and the hydrogen, measuring an amount of electricity drawn from the stack unit by a load, and controlling an amount of electricity generated by the stack unit based on the measurement.

Controlling the amount of electricity generated by the stack unit may include controlling an amount of hydrogen supplied to the stack unit. Controlling an amount of hydrogen supplied to the stack unit may include re-circulating hydrogen discharged from the stack unit back to the stack unit, with a fuel circulation blower, and controlling a driving voltage of the fuel circulation blower based on the measurement. The measurement may be a current value measurement, and controlling the driving voltage of the fuel circulation blower may include increasing the driving voltage of the fuel circulation blower when the current value measurement increases relative to a prior current value measurement, and decreasing the driving voltage of the fuel circulation blower when the current value measurement decreases relative to a prior current value measurement.

Controlling the amount of electricity generated by the stack unit may include controlling an amount of air which is supplied to the stack unit. Controlling an amount of air supplied to the stack unit may include supplying air from the air supply unit to the stack unit, with an air circulation blower, and controlling a driving voltage of the air circulation blower based on the measurement. The measurement may be a current value measurement, and controlling the driving voltage of the fuel circulation blower may include increasing the driving voltage of the air circulation blower when the current value measurement increases relative to a prior current value measurement, and decreasing the driving voltage of the air circulation blower when the current value measurement decreases relative to a prior current value measurement.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a schematic block diagram showing a conventional art fuel cell system;

FIG. 2 shows a distribution diagram of a fuel cell system according to an exemplary embodiment of the present invention;

FIG. 3 is a view showing an operational relationship between the load corresponding unit and the stack unit in FIG. 2 according to an embodiment of the present invention;

FIG. 4 is a view showing an operational relationship between the load corresponding unit and the stack unit according to another embodiment of the present invention; and

FIG. 5 is a view showing an operational relationship between the load corresponding unit and the stack unit according to another embodiment of the present invention.

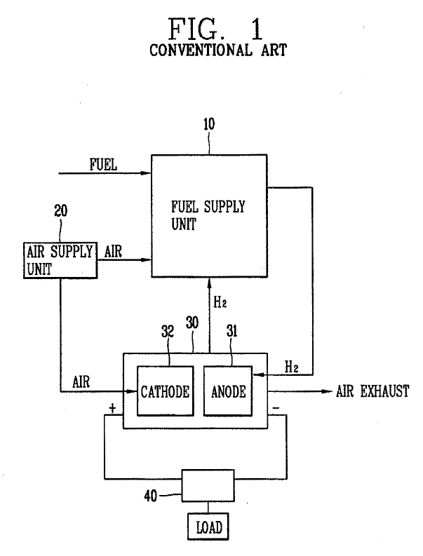

### DETAILED DESCRIPTION OF THE INVENTION

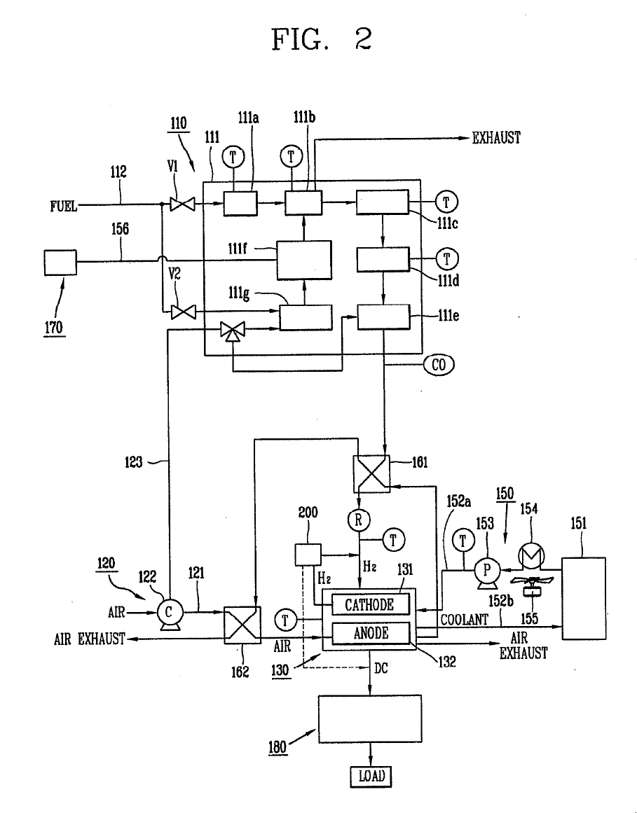

A fuel cell system according to an exemplary embodiment of the present invention will now be described with reference to the accompanying drawings. FIG. 2 shows a distribution diagram of a fuel cell system according to an exemplary embodiment of the present invention.

The fuel cell system shown in FIG. 2 includes a fuel supply unit 110 which supplies hydrogen; an air supply unit 120 which supplies air; a stack unit 130 which generates electricity from a reaction between the supplied hydrogen and air; a cooling unit 150 which cools the stack unit 130; a hot water supply unit 170 which supplies hot water to a steam generator 111f through a pipe 156; an electricity output unit 180 which converts direct current (DC) power generated by the stack unit 130 into AC power and supplies the AC power to a load; and a load corresponding unit 200 which measures a DC current value drawn from the stack unit 130 and controls an amount of hydrogen or air supplied to the stack unit 130.

The fuel supply unit 110 includes a reforming unit 111 which purifies hydrogen (H₂) from fuel (such as, for example, LNG) and supplies the hydrogen to an anode 131 of the stack unit 130, and a pipe 112 which supplies the fuel to the reforming unit 111. The reforming unit 111 includes a desulfurization reactor 111a which desulfurizes the fuel; a reforming reactor 111b that reforms the fuel and steam to generate hydrogen; a high temperature water reactor 111c and a low temperature water reactor 111d which react carbon monoxide generated by the reforming reactor 111b to generate additional hydrogen; a partial oxidation reactor 111e which removes carbon monoxide from the fuel, using air as a catalyst, to purify the hydrogen; a steam generator 111f which supplies steam to the reforming reactor 111b; and a burner 111g which heats the steam generator 111f.

The air supply unit 120 includes first and second supply lines 121 and 123, and an air supply fan 122. The first air supply line 121 is installed between the air supply fan 122 and a second pre-heater 162 in order to supply atmospheric air to the cathode 132. The second air supply line 123 is installed between the air supply fan 122 and the burner 111g in order to supply atmospheric air to the burner 111g.

The stack unit 130 includes the anode 131 and the cathode 132, and simultaneously generates electric energy and thermal energy from an electrochemical reaction of hydrogen supplied from the fuel supply unit 110, re-circulated hydrogen discharged from the stack unit 130, and air supplied from the air supply unit 120.

The cooling unit 150 cools the stack unit 130 of the fuel supply unit 110 by supplying water to the stack unit 130. The cooling unit 150 includes a water supply container 151 which charges water, water circulation lines 152a and 152b which circulate water between the stack unit 130 and the water supply container 151, a water circulation pump 153, installed at a middle portion of the water circulation line 152a, which pumps water out of the water supply container 151, a heat exchanger 154, provided at a middle portion of the water circulation line 152a, which cools the circulated water, and a heat dissipating fan 155.

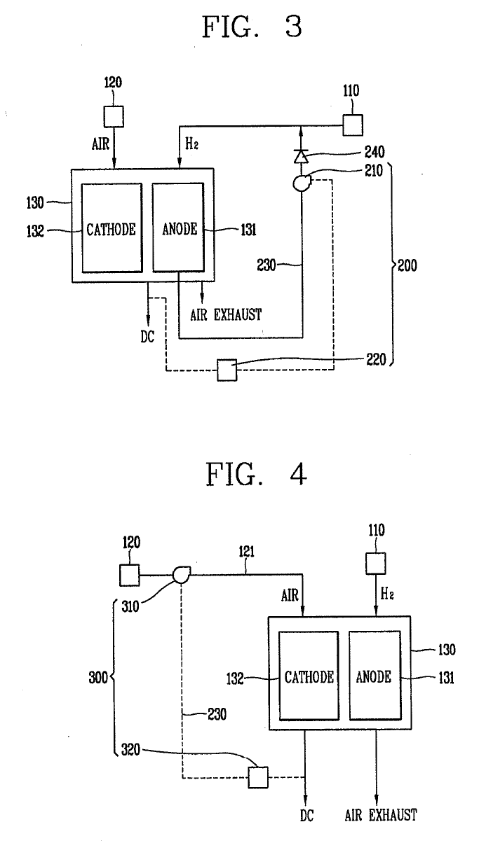

FIG. 3 shows an operational relationship between the load corresponding unit 200 and the stack unit 130, according to one embodiment of the invention. As shown in FIG. 3, the load corresponding unit 200 includes a fuel circulation blower 210 installed on a re-circulation line 230 to re-circulate hydrogen discharged by the anode 131 of the stack unit 130 back to the anode 131 of the stack unit 130; and a fuel controller 220 which measures a DC current value of electricity drawn from the stack unit 130 and controls a driving voltage of the fuel circulation blower 210.

The fuel circulation blower 210 may be, for example, a turbo fan or a centrifugal fan. The amount of re-circulated hydrogen supplied to the anode 131 of the stack unit 130 depends upon the rotational speed of the fuel circulation blower 210. In this regard, when the rotational speed of the fuel circulation blower 210 increases, the amount of re-circulated hydrogen supplied to the anode 131 of the stack unit 130 increases, and when the rotational speed of the fuel circulation blower 210 decreases, the amount of re-circulated hydrogen supplied to the anode 131 of the stack unit 130 decreases.

The rotational speed of the fuel circulation blower is determined based on the DC current value of the electricity drawn from the stack unit 130, which in turn, depends on the size of a load connected to the fuel cell system. When the load increases, the DC current value increases, while when the load is small, the DC current value is also small. Accordingly, the DC current value can be a variable for measuring the size of the load.

The fuel controller 220 may be implemented, for example, with a microcomputer. The fuel controller 200 controls a size of the driving voltage of the fuel circulation blower 210 by measuring the DC current value. When the DC current value is large, the driving voltage is increased in order to increase the rotational speed of the fuel circulation blower 210, thus increasing the amount of re-circulated hydrogen supplied to the anode 131 of the stack unit 130. On the other hand, if the DC current value is small, the driving voltage is lowered to reduce the rotational speed of the fuel circulation blower 210, thus reducing the amount of re-circulated hydrogen supplied to the anode 131 of the stack unit 130.

In this manner, by controlling the amount of re-circulated hydrogen according to the size of the load, the amount of hydrogen supplied to the anode 131 of the stack unit 130 can be precisely controlled to control the amount of electricity generated by the stack unit 130 in accordance with the load of the fuel cell system. The resulting reduction of consumption of hydrogen leads to improvement of the overall performance of the fuel cell system.

Reference numeral 240 denotes a backflow preventing valve (or check valve) which prevents hydrogen supplied from the hydrogen supply unit 110 from flowing back to the anode 131 through the re-circulation line 230.

FIG. 4 shows an operational relationship between a load corresponding unit 300 and the stack unit 130 according to another embodiment of the invention. In this embodiment, the load corresponding unit 300 includes an air circulation blower 310 installed on the first air supply line 121 which supplies air from the air supply unit 120 to the anode 132 of the stack unit 130; and an air controller 320 which measures a DC current value of electricity drawn from the stack unit 130 and controls a driving voltage of the air circulation blower 310.

In this embodiment, the load corresponding unit 300 includes the air circulation blower 310, rather than the fuel circulation blower 210, and controls the amount of air supplied to the stack unit 130 according to the DC current value of electricity drawn from the stack unit 130.

The air circulation blower 310 may be, for example, a turbo fan or a centrifugal fan. The amount of air supplied to the anode 132 of the stack unit 130 depends upon the rotational speed of the air circulation blower 310.

In this regard, when the rotational speed of the air circulation blower 310 increases, the amount of air supplied to the cathode 132 of the stack unit 130 increases, and when the rotational speed of the air circulation blower 310 decreases, the amount of air supplied to the cathode 132 of the stack unit 130 decreases.

The rotational speed is determined according to the size of the DC current value of the electricity drawn from the stack unit 130, which depends on the size of the load connected to the fuel cell system. When the load increases, the DC current value increases, and when the load is small, the DC current value becomes small. Accordingly, the DC current value can be a variable for measuring the size of the load.

The air controller 320, may be implemented, for example, with a microcomputer. The air controller 320 controls a size of the driving voltage of the air circulation blower 310 by measuring the DC current value, which varies in accordance with the size of the load. That is, when the DC current value is large, the rotational speed of the air circulation blower 310 is increased in order to increase the amount of air supplied to the cathode 132 of the stack unit 130. However, if the DC current value is small, the rotational speed of the air circulation blower 310 is reduced in order to reduce the amount of air supplied to the cathode 132 of the stack unit 130.

In this manner, by precisely controlling the amount of air supplied to the cathode 132 of the stack unit 130 according to the size of the load, the amount of electricity generated by the stack unit 130 can be controlled according to the load of the fuel cell system.

The resulting reduction of consumption of hydrogen leads to improvement of the overall performance of the fuel cell system.

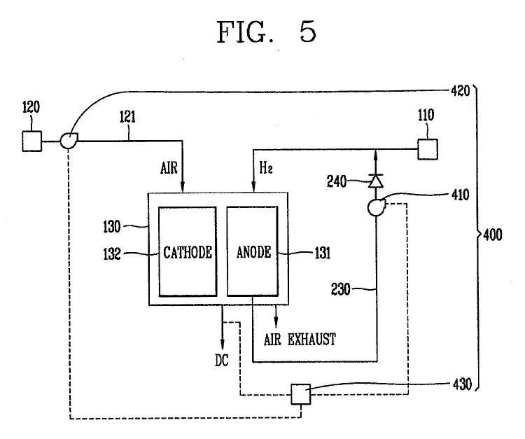

FIG. 5 shows an operational relationship between a load corresponding unit 400 and the stack unit 130 according to yet another embodiment of the present invention. Load corresponding unit 400 shown in FIG. 5 includes a fuel circulation blower 410 installed on the recirculation line 230 which re-circulates hydrogen discharged from the anode 131 of the stack unit 130 back to the anode 131 of the stack unit 130; an air circulation blower 420 installed on the first air supply line 121 which supplies air to the cathode 132 of the stack unit 130 from the air supply unit 120; and an integrated controller 430 which measures a value of the DC current of electricity drawn from the stack unit 130 and controls a driving voltage of both the fuel circulation blower 410 and the air circulation blower 420.

In this embodiment, the load corresponding unit 400 includes both the fuel circulation blower 410 and the air circulation blower 420, so the amount of hydrogen and air supplied to the stack unit 130 can be precisely controlled according to the DC current value of electricity drawn from the stack unit 130.

The fuel circulation blower 410 may be, for example, a turbo fan or a centrifugal fan. The amount of re-circulated hydrogen supplied to the anode 131 of the stack unit 130 depends on the rotational speed of the fuel circulation blower 410. Namely, when the rotational speed of the fuel circulation blower 410 increases, the amount of re-circulate hydrogen supplied to the anode 131 of the stack unit 130 increases, and when the rotational speed of the fuel circulation blower 210 decreases, the amount of re-circulated hydrogen supplied to the anode 131 of the stack unit 130 decreases.

The air circulation blower 420 may also be, for example, a turbo fan or a centrifugal fan. The amount of air supplied to the anode 132 of the stack unit 130 depends on the rotational speed of the air circulation blower 420. Namely, when the rotational speed of the air circulation blower 420 increases, the amount of air supplied to the cathode 132 of the stack unit 130 increases, and when the rotational speed of the air circulation blower 420 decreases, the amount of air supplied to the cathode 132 of the stack unit 130 decreases.

The rotational speed of the fuel circulation blower 410 and the air circulation blower 420 is determined according to the size of a value of the DC current of electricity drawn from the stack unit 130, which in turn depends on the size of a load connected to the fuel cell system. Namely, when the load increases, the DC current value increases, while when the load is small, the DC current value becomes small. Accordingly, the DC current value can be a variable for measuring the size of the load.

The integrated controller 430, may be implemented, for example, with a microcomputer. The integrated controller 430 controls a size of the driving voltage of the fuel circulation blower 410 and the air circulation blower 420 by measuring the DC current value, which varies in accordance with the size of the load. Namely, when the DC current value is large, the driving voltage is increased in order to increase the rotational speed of the fuel circulation blower 410 and the air circulation blower 420, to thus increase the amount of re-circulated hydrogen supplied to the anode 131 and air supplied to the cathode 132 of the stack unit 130.

However, if the DC current value is small, the driving voltage is decreased to reduce the rotational speed of the fuel circulation blower 410 and the air circulation blower 410 to thus reduce the amount of re-circulated hydrogen supplied to the anode 131 and the amount of air supplied to the cathode 132 of the stack unit 130.

In this manner, by controlling the amount of re-circulated hydrogen and the amount of air according to the size of the load, the amount of hydrogen supplied to the anode 131 of the stack unit 130 and the amount of air supplied to the anode 132 can be precisely controlled to thus control the amount of electricity generated by the stack unit 130 according to the load of the fuel cell system. Thus, the reduction of consumption of hydrogen and air leads to improvement of the overall performance of the fuel cell system.

Reference numeral 240 denotes a backflow preventing valve (a check valve) which prevents hydrogen supplied from the hydrogen supply unit 110 from flowing back to the anode 131 along the re-circulation line 230.

The operation and effect of the fuel cell system according to one embodiment of the present invention will be described with reference to FIGS. 2 and 3 as follows.

With reference to FIG. 2, the reforming unit 111 of the fuel supply unit 110 reforms fuel and steam to generate hydrogen, and supplies the hydrogen to the anode 131 of the stack unit 130.

Recirculated hydrogen discharged from the anode 131 of the stack unit 130 is supplied back to the anode 131 of the stack unit 130. The air supply unit 120 supplies air to the anode 132 of the stack unit 130. In this manner, the stack unit 130 generates electricity from an electrochemical reaction of the hydrogen, the recirculated hydrogen and the air.

When the load connected to the fuel cell system increases (uses an increased amount of electricity), the DC current value of electricity drawn from the stack unit 130 increases. Then, the fuel controller 220 increases the driving voltage of the fuel circulation blower 210. As the driving voltage is increased, the rotational speed of the fuel circulation blower 210 increases, the amount of recirculated hydrogen supplied to the anode 131 of the stack unit 130 increases, and accordingly, the amount of electricity generated by the stack unit 130 increases according to the increased load.

If the load decreases (uses less electricity), the DC current value of electricity drawn from the stack unit 130 is reduced. Then, the fuel controller 220 lowers the driving voltage of the fuel circulation blower 210. With the driving voltage lowered, the rotational speed of the fuel circulation blower 210 decreases to reduce the amount of recirculated hydrogen supplied to the anode 131 of the stack unit 130.

Accordingly, the amount of electricity generated by the stack unit 130 is reduced according to the reduced load.

As so far described, the fuel cell system according to the present invention has at least the following advantages.

The load corresponding unit measures the current value of electricity drawn from the stack unit and appropriately controls the amount of hydrogen and air supplied to the stack unit according to the size of the load. Because the amount of hydrogen and air supplied to the stack unit is precisely controlled according to the size of the load, the amount of electricity generated by the stack unit can be controlled according to the size of the load of the fuel cell system. Accordingly, the consumption of hydrogen and air is reduced, and the overall performance of the fuel cell system can be enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A fuel cell system, comprising:
a stack unit which generates electricity by an electrochemical reaction between air and hydrogen;
a fuel supply unit which supplies hydrogen to the stack unit;
an air supply unit which supplies air to the stack unit; and
a load corresponding unit which measures an amount of electricity drawn from the stack unit by a load, and controls an amount of electricity generated by the stack unit based on the measurement.

2. The fuel cell system according to claim 1, wherein the load corresponding unit controls the amount of electricity generated by the stack unit by controlling an amount of hydrogen supplied to the stack unit.

3. The fuel cell system according to claim 2, wherein the load corresponding unit comprises:
a fuel circulation blower which re-circulates hydrogen discharged from the stack unit back to the stack unit; and
a fuel controller which controls a driving voltage of the fuel circulation blower based on the measurement.

4. The fuel cell system according to claim 3, wherein the measurement comprises a current value measurement, and the fuel controller increases the driving voltage of the fuel circulation blower when the current value measurement increases relative to a prior current value measurement, and decreases the driving voltage of the fuel circulation blower when the current value measurement decreases relative to a prior current value measurement.

5. The fuel cell system according to claim 2, wherein the load corresponding unit controls the amount of electricity generated by the stack unit by controlling an amount of air supplied to the stack unit.

6. The fuel cell system according to claim 5, wherein the load corresponding unit comprises:
an air circulation blower which supplies air from the air supply unit to the stack unit; and
an air controller which controls a driving voltage of the air circulation blower based on the measurement.

7. The fuel cell system according to claim 6, wherein the measurement comprises a current value measurement, and the air controller increases the driving voltage of the air circulation blower when the current value measurement increases relative to a prior current value measurement, and decreases the driving voltage of the air circulation blower when the current value measurement decreases relative to a prior current value measurement.

8. The fuel cell system according to claim 1, wherein the load corresponding unit controls the amount of electricity generated by the stack unit by controlling an amount of air supplied to the stack unit.

9. The fuel cell system according to claim 8, wherein the load corresponding unit comprises:
an air circulation blower which supplies air from the air supply unit to the stack unit; and
an air controller which controls a driving voltage of the air circulation blower based on the measurement.

10. The fuel cell system according to claim 9, wherein the measurement is a current value measurement, and the air controller increases the driving voltage of the air circulation blower when the current value measurement increases relative to a prior current value measurement, and decreases the driving voltage of the air circulation blower when the current value measurement decreases relative to a prior current value measurement.

11. A method for controlling an amount of electricity generated by a fuel cell system, comprising:
supplying hydrogen and air to a stack unit;
generating electricity by an electrochemical reaction between the air and the hydrogen;
measuring an amount of electricity drawn from the stack unit by a load; and
controlling an amount of electricity generated by the stack unit based on the measurement.

12. The method according to claim 11, wherein controlling the amount of electricity generated by the stack unit comprises controlling an amount of hydrogen supplied to the stack unit.

13. The method according to claim 12, wherein controlling an amount of hydrogen supplied to the stack unit comprises:
re-circulating hydrogen discharged from the stack unit back to the stack unit, with a fuel circulation blower; and
controlling a driving voltage of the fuel circulation blower based on the measurement.

14. The method according to claim 13, wherein the measurement is a current value measurement, and controlling the driving voltage of the fuel circulation blower comprises increasing the driving voltage of the fuel circulation blower when the current value measurement increases relative to a prior current value measurement, and decreasing the driving voltage of the fuel circulation blower when the current value measurement decreases relative to a prior current value measurement.

15. The method according to claim 12, wherein controlling the amount of electricity generated by the stack unit comprises controlling an amount of air supplied to the stack unit.

16. The method according to claim 15, wherein controlling an amount of air supplied to the stack unit comprises:
supplying air from the air supply unit to the stack unit, with an air circulation blower; and
controlling a driving voltage of the air circulation blower based on the measurement.

17. The method according to claim 16, wherein the measurement is a current value measurement, and controlling the driving voltage of the fuel circulation blower comprises increasing the driving voltage of the air circulation blower when the current value measurement increases relative to a prior current value measurement, and decreasing the driving voltage of the air circulation blower when the current value measurement decreases relative to a prior current value measurement.

18. The method according to claim 11, wherein controlling the amount of electricity generated by the stack unit comprises controlling an amount of air supplied to the stack unit.

19. The method according to claim 18, wherein controlling an amount of air supplied to the stack unit comprises:
supplying air from the air supply unit to the stack unit, with an air circulation blower; and
controlling a driving voltage of the air circulation blower based on the measurement.

20. The method according to claim 19, wherein the measurement comprises a current value measurement, and controlling the driving voltage of the fuel circulation blower comprises increasing the driving voltage of the air circulation blower when the current value measurement increases relative to a prior current value measurement, and decreasing the driving voltage of the air circulation blower when the current value measurement decreases relative to a prior current value measurement.
